(19) United States
(12) Patent Application Publication
(10) Pub. No.: US 2022/0039047 A1
(43) Pub. Date: Feb. 3, 2022

(54) APPARATUSES AND METHODS FOR REDUCING THE NUMBER OF MULTIPLE-INPUT-MULTIPLE-OUTPUT (MIMO) LAYERS

(71) Applicant: MEDIATEK INC., Hsinchu City (TW)

(72) Inventors: Chih-Yuan TSAI, Hsinchu City (TW); Mohamed Abdelrazek EL-SAIDNY, Dubai (AE); Jun-Jie SU, Hsinchu City (TW)

(21) Appl. No.: 17/366,422

(22) Filed: Jul. 2, 2021

Related U.S. Application Data
(60) Provisional application No. 63/060,170, filed on Aug. 3, 2020.

(51) Int. Cl. H04W 60/04; H04W 24/10; H04W 8/24

(52) U.S. Cl. CPC H04W 60/04; H04W 8/24; H04W 24/10

(57) ABSTRACT

A User Equipment (UE) including a wireless transceiver and a controller is provided. The wireless transceiver performs wireless transmission and reception to and from a mobile communication network. The controller determines whether a trigger condition is met. In response to the trigger condition being met, the controller reports a first value representing a first Rank Indicator (RI) or a second value representing the UE's capability of Multiple-Input-Multiple-Output (MIMO) layers to the mobile communication network via the wireless transceiver. In particular, the first value is less than a third value representing a second RI derived from a measurement by the UE, or the second value is less than a fourth value representing a number of maximum MIMO layers supported by the UE.

### CROSS REFERENCE TO RELATED APPLICATIONS

This application claims priority under 35 U.S.C. § 119 from U.S. Provisional Application No. 63/060,170, entitled “Overheating Protection by sending fake RI to reduce MIMO layer”, filed on Aug. 3, 2020, the subject matter of which is incorporated herein by reference.

### BACKGROUND OF THE APPLICATION

### Field of the Application

The application generally relates to mobile communications and, more particularly, to apparatuses and methods for reducing the number of Multiple-Input-Multiple-Output (MIMO) layers.

### Description of the Related Art

In a typical mobile communication environment, a User Equipment (UE) (also called a Mobile Station (MS)), such as a mobile telephone (also known as a cellular or cell phone), or a tablet Personal Computer (PC) with wireless communication capability may communicate voice and/or data signals with one or more mobile communication networks. The wireless communication between the UE and the mobile communication networks may be performed using various Radio Access Technologies (RATs), such as Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, and New Radio (NR) technology etc. In particular, GSM/GPRS/EDGE technology is also called 2G technology; WCDMA/CDMA-2000/TD-SCDMA technology is also called 3G technology; LTE/LTE-A/TD-LTE technology is also called 4G technology; and NR technology is also called 5G technology.

In 4G/5G systems, a technique called Multiple-Input-Multiple-Output (MIMO) is used to increase the data throughput by using multiple transmitter antenna and multiple receiver antenna. Generally speaking, MIMO can be referred to as the ability to transmit multiple data streams (or called “layers”), using the same time and frequency resource, where each data stream can be beamformed. MIMO builds on the basic principle that when the received signal quality is high, it is better to receive multiple streams of data with reduced power per stream, than one stream with full power. The potential is especially large when the received signal quality is high and the streams do not interfere with each other.

However, activating the MIMO functionality will inevitably increase the UE's power consumption and result in overheating of the UE. In addition, the number of MIMO layers that the UE operates with is configured by the network, and there are situations where a dual-Subscriber Identity Module (SIM) UE may be configured with the number of maximum MIMO layers for one SIM, causing the other SIM to be unable to obtain antenna access for a Reception (Rx) operation (e.g., receiving call notification).

Therefore, it is desirable to have a robust way for a UE to reduce the number of MIMO layers.

### BRIEF SUMMARY OF THE APPLICATION

The present application proposes a robust way for a UE to reduce the number of MIMO layers, by allowing the UE to report a fake Rank Indicator (RI) value or fake number of supported MIMO layers, especially when the UE Assistance Information message is not supported by the UE and/or the network. Advantageously, the network may be enabled by the fake report to reduce the number of MIMO layers that the UE operates with.

In one aspect of the application, a UE comprising a wireless transceiver and a controller is provided. The wireless transceiver is configured to perform wireless transmission and reception to and from a mobile communication network. The controller is configured to determine whether a trigger condition is met, and in response to the trigger condition being met, report a first value representing a first Rank Indicator (RI) or a second value representing the UE's capability of Multiple-Input-Multiple-Output (MIMO) layers to the mobile communication network via the wireless transceiver, wherein the first value is less than a third value representing a second RI derived from a measurement by the UE, or the second value is less than a fourth value representing a number of maximum MIMO layers supported by the UE.

In another aspect of the application, a method is provided. The method comprises the following steps: communicatively connecting to a mobile communication network by a UE; determining, by the UE, whether a trigger condition is met; and in response to the trigger condition being met, reporting a first value representing a first RI or a second value representing a number of MIMO layers to the mobile communication network by the UE, wherein the first value is less than a third value representing a second RI derived from a measurement by the UE, or the second value is less than a fourth value representing a number of maximum MIMO layers supported by the UE.

In one embodiment, the first value or the second value is 1, 2, or 3.

In one embodiment, the trigger condition is that the UE experiences internal overheating, or that a power saving mode of the UE is activated, or that a band combination applied in the wireless transceiver is unable to allow simultaneous Rx operations associated with multiple SIMS in the UE.

In one embodiment, the UE further determines whether a number of MIMO layers that the UE operates with is greater than or equal to 2 in response to the trigger condition being met, and the reporting of the first value or the second value is performed in response to the number of MIMO layers that the UE operates with being greater than or equal to 2.

In one embodiment, the UE further determines whether the UE is configured to provide UE assistance information in response to the trigger condition being met, and the reporting of the first value is performed in response to the UE not being configured to provide UE assistance information. Moreover, the UE further transmits a UE Assistance Information message comprising the second value to the mobile communication network via the wireless transceiver, in response to the UE being configured to provide UE assistance information.

In one embodiment, the UE further receives Downlink Control Information (DCI) comprising an indication to reduce a number of MIMO layers that the UE operates with, after reporting the first value, and reduces the number of MIMO layers that the UE operates with according to the indication.

In one embodiment, the first value is reported in a Physical (PHY) layer message, or the second value is reported in a Tracking Area Update (TAU) message, an Attach Request message, or a Registration Request message.

In one embodiment, the UE further transmits a first SCG (Secondary Cell Group) Failure Information message to the mobile communication network via the wireless transceiver in response to the trigger condition being met, prior to reporting the second value. Moreover, the UE further transmits a second SCG Failure Information message to the mobile communication network via the wireless transceiver in response to the trigger condition no longer being met, and reports the fourth value to the mobile communication network via the wireless transceiver.

Other aspects and features of the present application will become apparent to those with ordinarily skill in the art upon review of the following descriptions of specific embodiments of the apparatuses and methods for reducing the number of MIMO layers.

### BRIEF DESCRIPTION OF THE DRAWINGS

The present application can be more fully understood by reading the subsequent detailed description and examples with references made to the accompanying drawings, wherein:

FIG. 1 is a block diagram of a mobile communication environment according to an embodiment of the application;

FIG. 2 is a block diagram illustrating the UE 110 according to an embodiment of the application;

FIG. 3 is a message sequence chart illustrating the reporting of a fake RI value to reduce the number of MIMO layers according to an embodiment of the application;

FIG. 4 is a message sequence chart illustrating the reporting of a fake number of supported MIMO layers to reduce the number of MIMO layers according to an embodiment of the application; and

FIG. 5 is a flow chart illustrating the method for reducing the number of MIMO layers according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises”, “comprising”, “includes”, and/or “including” when used herein, specify the presence of stated features, integers, steps, operations, elements, and/or components, but do not preclude the presence or addition of one or more other features, integers, steps, operations, elements, components, and/or groups thereof.

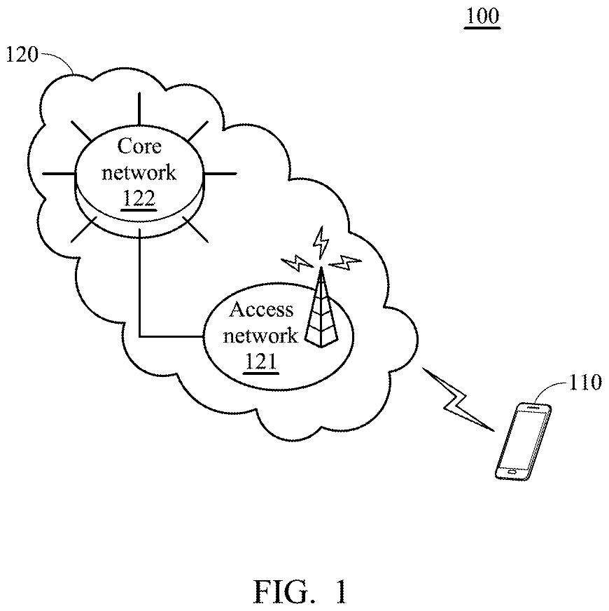

FIG. 1 is a block diagram of a mobile communication environment according to an embodiment of the application.

As shown in FIG. 1, the mobile communication environment 100 includes a User Equipment (UE) 110 and a mobile communication network 120.

The UE 110 may be a feature phone, a smartphone, a panel Personal Computer (PC), a laptop computer, a Machine Type Communication (MTC) device, or any mobile communication device supporting the RATs utilized by the mobile communication network 120. The UE 110 may connect to the mobile communication network 120 to obtain mobile services (e.g., voice and/or data services).

The mobile communication network 120 may include an access network 121 and a core network 122. The access network 121 is responsible for processing radio signals, terminating radio protocols, and connecting the UE 110 with the core network 122, while the core network 122 is responsible for performing mobility management, network-side authentication, and interfaces with public/external networks (e.g., the Internet).

In one embodiment, if the mobile communication network 120 is a 4G network (e.g., an LTE/LTE-A/TD-LTE network), the access network 121 may be an Evolved-Universal Terrestrial Radio Access Network (E-UTRAN) and the core network 122 may be an Evolved Packet Core (EPC). The E-UTRAN may include at least an evolved NodeB (eNB) (e.g., a macro eNB, femto eNB, or pico eNB). The EPC may include a Home Subscriber Server (HSS), Mobility Management Entity (MME), Serving Gateway (S-GW), and Packet Data Network Gateway (PDN-GW or P-GW).

In one embodiment, if the mobile communication network 120 is a standalone 5G network (e.g., an NR network), the access network 121 may be a Next Generation Radio Access Network (NG-RAN) and the core network 122 may be a Next Generation Core Network (NG-CN). The NG-RAN may include one or more gNBs. Each gNB may further include one or more Transmission Reception Points (TRPs), and each gNB or TRP may be referred to as a 5G cellular station. Some gNB functions may be distributed across different TRPs, while others may be centralized, leaving the flexibility and scope of specific deployments to fulfill the requirements for specific cases. The NG-CN may support various network functions, including an Access and Mobility Management Function (AMF), a Session Management Function (SMF), a User Plane Function (UPF), a Policy Control Function (PCF), an Application Function (AF), an Authentication Server Function (AUSF), and a Non-3GPP Inter-Working Function (N3IWF), wherein each network function may be implemented as a network element on dedicated hardware, or as a software instance running on dedicated hardware, or as a virtualized function instantiated on an appropriate platform, e.g., a cloud infrastructure.

In another embodiment, the mobile communication network 120 is a non-standalone (NSA) 5G network (i.e., an LTE-NR interworking system), in which the core network 122 is still a 4G core (e.g., an Evolved Packet Core (EPC), and the access network 121 includes both an E-UTRAN and a NG-RAN. If the UE 110 supports EUTRA-NR Dual Connectivity (EN-DC), the UE 110 may communicate with both an eNB and a gNB in the radio aspect, but all those communications (i.e., signaling and/or data) are going through an EPC. Particularly, the eNB serves as the Master Node (MN), while the gNB serves as the Secondary Node (SN). In case of data plane communication, each of the MN and the SN has direct interface with the EPC (e.g., the S-GW), while in case of control plane communication, only the SN has direct interface with the EPC (e.g., the MME).

In accordance with one novel aspect, the UE 110 is allowed to report a fake Rank Indicator (RI) value or a fake number of supported MIMO layers, to enable the mobile communication network 120 to reduce the number of MIMO layers that the UE 110 operates with. Please note that the fake reporting may be triggered in one of the following conditions: (1) the UE experiences internal overheating; (2) the power saving mode of the UE is activated; and (3) the band combination applied in the UE's wireless transceiver is unable to allow simultaneous Reception (Rx) operations associated with multiple Subscriber Identity Modules (SIMs).

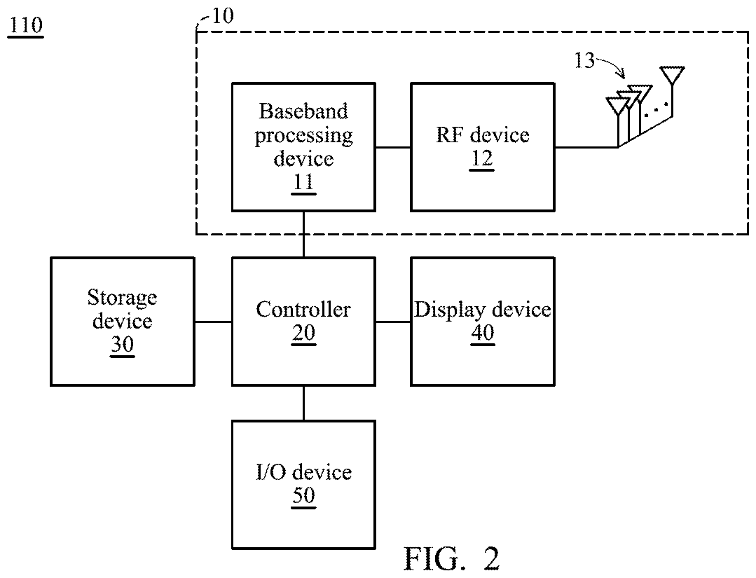

FIG. 2 is a block diagram illustrating the UE 110 according to an embodiment of the application.

As shown in FIG. 2, the UE 110 may include a wireless transceiver 10, a controller 20, a storage device 30, a display device 40, and an Input/Output (I/O) device 50.

The wireless transceiver 10 is configured to perform wireless transmission and reception to and from the mobile communication network 120. Specifically, the wireless transceiver 10 may include a baseband processing device 11, a Radio Frequency (RF) device 12, and antenna 13, wherein the antenna 13 may include an antenna array for beamforming.

The baseband processing device 11 is configured to perform baseband signal processing and control the communications between subscriber identity card(s) (e.g., one or more SIMS) and/or one or more Universal SIMs (USIMs)) (not shown) and the RF device 12. The baseband processing device 11 may contain multiple hardware components to perform the baseband signal processing, including Analog-to-Digital Conversion (ADC)/Digital-to-Analog Conversion (DAC), gain adjusting, modulation/demodulation, encoding/decoding, and so on.

The RF device 12 may receive RF wireless signals via the antenna 13, convert the received RF wireless signals to baseband signals, which are processed by the baseband processing device 11, or receive baseband signals from the baseband processing device 11 and convert the received baseband signals to RF wireless signals, which are later transmitted via the antenna 13. The RF device 12 may also contain multiple hardware devices to perform radio frequency conversion. For example, the RF device 12 may include a mixer to multiply the baseband signals with a carrier oscillated in the radio frequency of the supported cellular technologies, wherein the radio frequency may be 900 MHz, 2100 MHz, or 2.6 GHz utilized in 4G (e.g., LTE/LTE-A/TD-LTE) systems, or may be any radio frequency (e.g., 30 GHz-300 GHz for mmWave, or 3.3 GHz-4.9 GHz for sub-6) utilized in 5G (e.g., NR) systems, or another radio frequency, depending on the RAT in use.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless transceiving with the mobile communication network 120, enabling the storage device 30 for storing and retrieving data, sending a series of frame data (e.g. representing text messages, graphics, images, etc.) to the display device 40, and receiving/outputting signals from/to the I/O device 50.

In particular, the controller 20 coordinates the aforementioned operations of the wireless transceiver 10, the storage device 30, the display device 40, and the I/O device 50 for performing the method for reducing the number of MIMO layers.

In another embodiment, the controller 20 may be incorporated into the baseband processing device 11, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 is a non-transitory computer-readable storage medium, including a Universal Integrated Circuit Card (UICC) (e.g., a Subscriber Identity Module (SIM) or Universal SIM (USIM) card), a memory (e.g., a FLASH memory or a Non-Volatile Random Access Memory (NVRAM)), a magnetic storage device (e.g., a hard disk or a magnetic tape), or an optical disc, or any combination thereof for storing data, instructions, and/or program code of applications, communication protocols, and/or the method of the present application.

The display device 40 may be a Liquid-Crystal Display (LCD), a Light-Emitting Diode (LED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users, such as receiving user inputs, and outputting prompts to users.

It should be understood that the components described in the embodiment of FIG. 2 are for illustrative purposes only and are not intended to limit the scope of the application. For example, the UE 110 may include more components, such as a power supply, or a Global Positioning System (GPS) device, wherein the power supply may be a mobile/replaceable battery providing power to all the other components of the UE 110, and the GPS device may provide the location information of the UE 110 for use of some location-based services or applications. Alternatively, the UE 110 may include fewer components. For example, the UE 110 may not include the display device 40 and/or the I/O device 50.

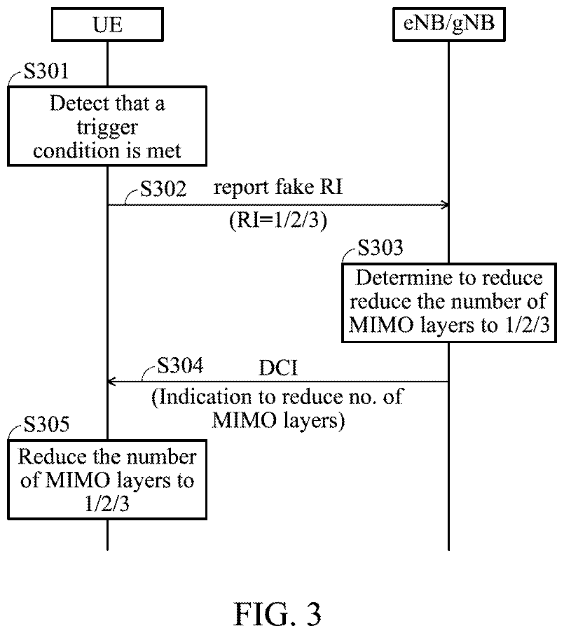

FIG. 3 is a message sequence chart illustrating the reporting of a fake RI value to reduce the number of MIMO layers according to an embodiment of the application.

In step S301, the UE detects that a trigger condition is met.

In step S302, the UE reports a fake RI value (e.g., RI=1, 2, or 3) to the eNB/gNB in response to the trigger condition being met. For example, the RI value may be reported in a Physical (PHY) layer message (e.g., the RI value may be included in a Channel State Information (CSI) report sent over the Physical Uplink Control Channel (PUCCH) or Physical Uplink Shared Channel (PUSCH)). It should be noted that the fake RI value is less than the true RI value (e.g., 4) derived from the measurement by the UE.

In step S303, the eNB/gNB determines to reduce the number of MIMO layers that the UE operates with to 1, 2, or 3 in response to the reported RI value.

In step S304, the eNB/gNB transmits Downlink Control Information (DCI) with an indication to reduce the number of MIMO layers to the UE. In one embodiment, the DCI may be a UE-specific DCI with a DCI format 0_0/0_1/1_0/1_1 in a 5G network. In another embodiment, the DCI may be a UE-specific DCI with a DCI format 1/1A/1B/1C/1D/2/2A in a 4G network. For example, the DCI may be a DCI format 1_1 including a field called “Antenna port(s) and number of layers” for configuration of the MIMO functionality, and thus, the indication can be understood as an indication to reduce the number of MIMO layers to 1 if this field is set to value 0/1/3/4/5/6 for Single-Input-Single-Output (SISO), or can be understood as an indication to reduce the number of MIMO layers to 2 if this field is set to value 2/7/8/11, or can be understood as an indication to reduce the number of MIMO layers to 3 if this field is set to value 9.

In step S305, the UE reduces the number of MIMO layers according to the indication in the received DCI.

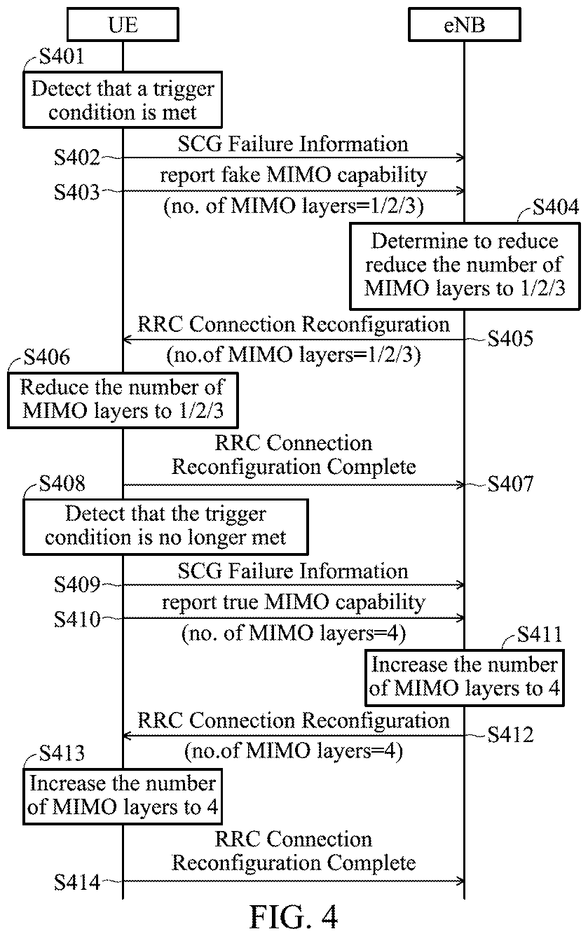

FIG. 4 is a message sequence chart illustrating the reporting of a fake number of supported MIMO layers to reduce the number of MIMO layers according to an embodiment of the application.

In this embodiment, the mobile communication network to which the UE is communicatively connected is an NSA 5G network.

In step S401, the UE detects that a trigger condition (e.g., the UE experiences internal overheating) is met.

In step S402, the UE transmits a SCG (Secondary Cell Group) Failure Information message to the eNB to disconnect the SCG connection.

In step S403, the UE reports the UE's fake capability regarding the number of maximum MIMO layers=1, 2, or 3 to the eNB in response to the trigger condition being met. For example, the fake value of the number of maximum MIMO layers may be reported in a Tracking Area Update (TAU) message, an Attach Request message, or a Registration Request message. It should be noted that the fake value is less than the true value (.e.g., 4) of the number of maximum MIMO layers supported by the UE.

In step S404, the eNB determines to reduce the number of MIMO layers that the UE operates with to 1, 2, or 3 in response to the reported value.

In step S405, the eNB transmits an RRC (Radio Resource Control) Connection Reconfiguration message for SCG addition with the reduced number of MIMO layers to the UE.

In step S406, the UE reduces the number of MIMO layers according to the RRC Connection Reconfiguration message.

In step S407, the UE transmits an RRC Connection Reconfiguration Complete message to the eNB.

In step S408, the UE detects that the trigger condition is no longer met (e.g., internal overheating no more).

In step S409, the UE transmits a SCG (Secondary Cell Group) Failure Information message to the eNB to disconnect the SCG connection.

In step S410, the UE reports the UE's true capability regarding the number of maximum MIMO layers=4 to the eNB in response to the trigger condition no longer being met.

In step S411, the eNB determine to increase the number of MIMO layers that the UE operates with to 4 in response to the reported value.

In step S412, the eNB transmits an RRC Connection Reconfiguration message for SCG addition with the increased number of MIMO layers to the UE.

In step S413, the UE increases the number of MIMO layers according to the RRC Connection Reconfiguration message.

In step S414, the UE transmits an RRC Connection Reconfiguration Complete message to the eNB.

Please note that, in another embodiment, the reporting of a fake number of supported MIMO layers as described in FIG. 4 may be performed, after reporting a fake RI value but the network doesn't provide DCI indication for reducing the number of MIMO layers.

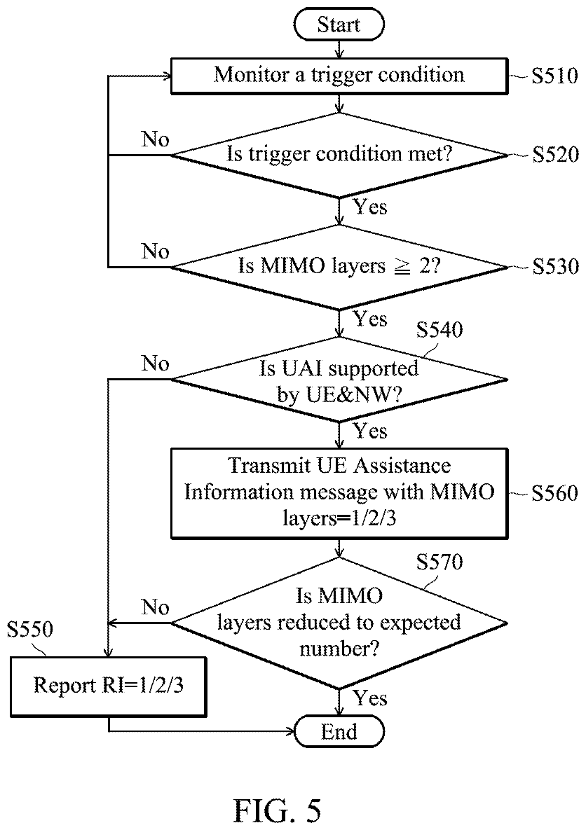

FIG. 5 is a flow chart illustrating the method for reducing the number of MIMO layers according to an embodiment of the application.

In this embodiment, the method is applied to and executed by a UE (e.g., the UE 110) communicatively connected to a mobile communication network (e.g., the mobile communication network 120).

In step S510, the UE monitors a trigger condition.

In one embodiment, the trigger condition is that the UE experiences internal overheating.

In another embodiment, the trigger condition is that the power saving mode of the UE is activated.

In yet another embodiment, the trigger condition is that the band combination applied in the UE's wireless transceiver is unable to allow simultaneous Rx operations associated with multiple SIMS in the UE. For example, in a dual-SIM UE using a first frequency band for SIM1 and a second frequency band for SIM2, simultaneous Rx operations associated with these two SIMs may not be allowed if the UE is configured to operate with the number of maximum MIMO layers for either SIM1 or SIM2 (i.e., access to all antennas will be occupied by a single SIM).

In step S520, the UE determines whether the trigger condition is met.

Subsequent to step S520, if the trigger condition is met, the method proceeds to step S530. Otherwise, if the trigger condition is not met, the method returns to step S510 to keep monitoring the trigger condition.

In step S530, the UE determines a number of MIMO layers that the UE operates with is greater than or equal to 2.

Subsequent to step S530, if the number of MIMO layers that the UE operates with is greater than or equal to 2, the method proceeds to step S540. Otherwise, if the number of MIMO layers that the UE operates with is less than 2, the method returns to step S510 to keep monitoring the trigger condition.

In step S540, the UE determines whether the UE Assistance Information message is supported by both the UE and the mobile communication network (i.e., whether the UE is configured to provide UE assistance information). In other words, the UE may be configured to provide UE assistance information only if the UE Assistance Information message is supported by both the UE and the mobile communication network.

Subsequent to step S540, if the UE Assistance Information message is not supported by both the UE and the mobile communication network (i.e., the UE is not configured to provide UE assistance information), the method proceeds to step S550. Otherwise, if the UE Assistance Information message is supported by both the UE and the mobile communication network (i.e., the UE is configured to provide UE assistance information), the method proceeds to step S560.

In step S550, the UE reports a fake RI value (e.g., RI=1, 2, or 3) or a fake number of supported maximum MIMO layers (e.g., maxMIMOlayers=1, 2, or 3) to the mobile communication network, wherein the fake RI value (e.g., 1, 2, or 3) is less than the true RI value (e.g., 4) derived from the measurement by the UE, and the fake number (e.g., 1, 2, or 3) of supported maximum MIMO layers is less than the true value (.e.g., 4) of the number of maximum MIMO layers supported by the UE.

In step S560, the UE transmits a UE Assistance Information message comprising the fake number of supported MIMO layers (also referred to as reduced number of maximum MIMO layers, e.g., the “reducedMaxMIMO-LayersFR1” parameter in the OverheatingAssistance Information Element (IE)) to the mobile communication network.

In step S570, the UE determines whether the number of MIMO layers that the UE operates with is reduced to the UE's expectation.

Subsequent to step S570, if the number of MIMO layers that the UE operates with is reduced to the UE's expectation, the method ends. Otherwise, if the number of MIMO layers that the UE operates with is not reduced to the UE's expectation, the method proceeds to step S550.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A User Equipment (UE), comprising:
a wireless transceiver, configured to perform wireless transmission and reception to and from a mobile communication network; and
a controller, configured to determine whether a trigger condition is met, and in response to the trigger condition being met, report a first value representing a first Rank Indicator (RI) or a second value representing the UE's capability of Multiple-Input-Multiple-Output (MIMO) layers to the mobile communication network via the wireless transceiver, wherein the first value is less than a third value representing a second RI derived from a measurement by the UE, or the second value is less than a fourth value representing a number of maximum MIMO layers supported by the UE.

2. The UE as claimed in claim 1, wherein the first value or the second value is 1, 2, or 3.

3. The UE as claimed in claim 1, wherein the trigger condition is that the UE experiences internal overheating, or that a power saving mode of the UE is activated, or that a band combination applied in the wireless transceiver is unable to allow simultaneous Reception (Rx) operations associated with multiple Subscriber Identity Modules (SIMs) in the UE.

4. The UE as claimed in claim 1, wherein the controller further determines whether a number of MIMO layers that the UE operates with is greater than or equal to 2, in response to the trigger condition being met, and the reporting of the first value or the second value is performed in response to the number of MIMO layers that the UE operates with being greater than or equal to 2.

5. The UE as claimed in claim 1, wherein the controller further determines whether the UE is configured to provide UE assistance information, in response to the trigger condition being met, and the reporting of the first value is performed in response to the UE not being configured to provide UE assistance information.

6. The UE as claimed in claim 5, wherein the controller further transmits a UE Assistance Information message comprising the second value to the mobile communication network via the wireless transceiver, in response to the UE being configured to provide UE assistance information.

7. The UE as claimed in claim 1, wherein the controller further receives Downlink Control Information (DCI) comprising an indication to reduce a number of MIMO layers that the UE operates with, after reporting the first value, and reduces the number of MIMO layers that the UE operates with according to the indication.

8. The UE as claimed in claim 1, wherein the first value is reported in a Physical (PHY) layer message, or the second value is reported in a Tracking Area Update (TAU) message, an Attach Request message, or a Registration Request message.

9. The UE as claimed in claim 1, wherein the controller further transmits a first SCG (Secondary Cell Group) Failure Information message to the mobile communication network via the wireless transceiver in response to the trigger condition being met, prior to reporting the second value.

10. The UE as claimed in claim 9, wherein the controller further transmits a second SCG Failure Information message to the mobile communication network via the wireless transceiver in response to the trigger condition no longer being met, and reports the fourth value to the mobile communication network via the wireless transceiver.

11. A method, comprising:
communicatively connecting to a mobile communication network by a UE;
determining, by the UE, whether a trigger condition is met; and
in response to the trigger condition being met, reporting a first value representing a first RI or a second value representing a number of MIMO layers to the mobile communication network by the UE, wherein the first value is less than a third value representing a second RI derived from a measurement by the UE, or the second value is less than a fourth value representing a number of maximum MIMO layers supported by the UE.

12. The method as claimed in claim 11, wherein the first value or the second value is 1, 2, or 3.

13. The method as claimed in claim 11, wherein the trigger condition is that the UE experiences internal overheating, or that a power saving mode of the UE is activated, or that a band combination applied in the wireless transceiver is unable to allow simultaneous Rx operations associated with multiple SIMs in the UE.

14. The method as claimed in claim 11, further comprising:
determining whether a number of MIMO layers that the UE operates with is greater than or equal to 2, in response to the trigger condition being met; and
wherein the reporting of the first value or the second value is performed in response to the number of MIMO layers that the UE operates with being greater than or equal to 2.

15. The method as claimed in claim 11, further comprising:
determining whether the UE is configured to provide UE assistance information, in response to the trigger condition being met; and
wherein the reporting of the second value is performed in response to the UE not being configured to provide UE assistance information.

16. The method as claimed in claim 15, further comprising:
transmitting a UE Assistance Information message comprising the second value to the mobile communication network by the UE, in response to the UE being configured to provide UE assistance information.

17. The method as claimed in claim 11, further comprising:
receiving DCI comprising an indication to reduce a number of MIMO layers that the UE operates with, after reporting the first value; and
reducing the number of MIMO layers that the UE operates with according to the indication.

18. The method as claimed in claim 11, wherein the first value is reported in a PHY layer message, or the second value is reported in a TAU message, an Attach Request message, or a Registration Request message.

19. The method as claimed in claim 11, further comprising:
transmitting a first SCG Failure Information message to the mobile communication network by the UE in response to the trigger condition being met, prior to reporting the second value.

20. The method as claimed in claim 19, further comprising:
transmitting a second SCG Failure Information message to the mobile communication network by the UE in response to the trigger condition no longer being met; and
reporting the fourth value to the mobile communication network by the UE.
